(19) United States
(12) Patent Application Publication
(10) Pub. No.: US 2009/0106040 A1
(43) Pub. Date: Apr. 23, 2009

(54) System And Method For Synchronous Recommendations of Social Interaction Spaces to Individuals

(75) Inventor: Quentin Jones, New Brunswick, NJ (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: NEW JERSEY INSTITUTE OF TECHNOLOGY, Newark, NJ (US)

(21) Appl. No.: 12/256,084

(22) Filed: Oct. 22, 2008

Related U.S. Application Data
(60) Provisional application No. 60/982,065, filed on Oct. 23, 2007.

(51) Int. Cl. G06Q 30/00

(52) U.S. Cl. 705/1

(57) ABSTRACT

A system and method for recommending a social interaction space to an individual are disclosed. Real-time information about users and a social interaction environment are gathered. A real-time, general model of the social interaction environment, including social interaction space states, trajectories, and rhythms, is created, as well as real-time profiles of the users. Affinities are calculated between modeled environment and user profiles, and social interaction spaces of the modeled environment are recommended to the user based upon the calculated affinities.

### RELATED APPLICATIONS

This application claims the benefit of U.S. Provisional Application Ser. No. 60/982,065 filed Oct. 23, 2007, the entire disclosure of which is expressly incorporated herein by reference.

### BACKGROUND

1. Technical Field

The present disclosure relates to social interaction space recommendation systems and, more particularly, to a system and method for synchronous recommendations of social interaction spaces by real-time modeling and profiling of a social interaction environment and individuals.

2. Related Art

Various recommendation systems have, in the past, been developed for recommending items to individuals, such as books and movies. Recently, social recommendation systems have been developed, which can be categorized into two main forms: social matching systems and social interaction space recommendation systems. Social matching systems are systems that recommend individuals to each other. Such systems typically provide individuals with access to various aspects of other individuals' profiles through listings or social network visualizations, which are extended to include match alerts and introduction management tools which aim to encourage interpersonal contact. Examples of social matching systems include systems for finding others with similar social interests (www.friendster.com), systems for business networking (www.linkedin.com), knowledge management systems (www.tacit.com), and systems for online dating (www.eharmony.com).

Social interaction space recommendation systems, the second type of social recommendation systems, are systems which suggest various social interaction space or social venues to individuals. Social interaction spaces or venues can be physical/situated in the real world (such as a community pub, a town hall meeting room, music concerts etc.), online (such as online computer chat rooms, etc.), or mixed reality (i.e., venues which represent a combination of physical and online venues). Like real world venues, online social interaction spaces allow public, shared, interpersonal communications. This can be achieved through the utilization of computer-mediated communication technologies, such as e-mail, e-mail lists, Internet Relay Chat (TRC) clients and channels, and Usenet clients and newsgroups. Both online and physical social interaction spaces can be empty or crowded, public or private, and can have rhythmic patterns of activity.

A particular drawback of existing social interaction space recommendation systems is that they do not profile, in real time, both individuals and social interaction spaces to make recommendations of spaces to individuals. Rather, existing systems typically recommend social interaction spaces to individuals based upon asynchronous information (e.g., information about an event at a venue entered into the system at a time that is independent of when the relevant event(s) is/are occurring) or historical information (e.g., information about a type of event typically occurring at a venue) so as to allow search algorithms to match an individual to a space (e.g., in a situation where an individual is attempting to locate an e-mail discussion list about dogs, or places). For example, while the website www.meetup.com allows users to specify interested topics and creates social interaction spaces based upon the specified topics, it does not allow for the real-time modeling of the created social interaction spaces and the generation of synchronous recommendations of specific social interaction spaces to individuals based upon real-time modeling of the environment and/or individual. As such, existing social interaction space systems do not adequately generate and utilize real-time profiles of both individuals and social interaction spaces, nor do they allow for real-time monitoring of changes in individual and social interaction space states to provide flexible and dynamic recommendations in changing environments.

Despite efforts to date, improved social interaction space recommendation systems are needed which offer real-time profiling of individuals and social interaction spaces to provide accurate and useful recommendations of spaces to individuals. These and other needs are addressed in the system and method disclosed herein.

### SUMMARY

The present disclosure relates to a system and method for synchronous recommendations of social interaction spaces to individuals. Real-time information about individuals, a social interaction environment (e.g., an urban campus, a downtown urban enclave, a chat network, etc., and the social interaction spaces within said environments, such as class rooms, cafeterias, chat channels, etc.), and the interactions dynamics of the user community, are gathered to create a dynamic (i.e., near real-time) general model of the social interaction environment and dynamic profiles of individuals. The general model of the interaction environment includes real-time information as to the current states of social interaction spaces (e.g., the number of individuals currently in each space), the short-term and long-term trajectories (e.g., occupancy trends) and rhythms (e.g., activity levels) corresponding to each space, and idealized social interaction space states. This information could be acquired through monitoring and modeling of the environment to understand various metrics such as maximum occupancy, or provided by users of the system of the present disclosure (e.g., information provided by a club meeting convener regarding the types and number of people who would ideally attend an event).

Profiled information about individuals generally includes information about each individual's current state (e.g., the current location, physical or virtual, of the individual and the individual's engagement in various activities, etc.), as well as the individual's explicit and implicit social interaction space preferences. The user community can also be profiled to identify social network ties, broad patterns of social activity, group preferences and the relationships of such ties, patterns and group preferences to various social interaction spaces, to better profile both individual users and social interaction spaces. Affinities are calculated by graphing the real-time model of the social interaction spaces in an environment and user profiles to produced weighted affinity scores. Social interaction spaces of the modeled environment are recommended to the user based upon the calculated affinities after taking into account appropriate contextual constraint information (e.g., a user should not be recommended a location that he or she already currently occupies). The disclosed systems and methods can be utilized to model a variety of social interaction environments, such as chat networks, campus locations, and urban enclaves, and to make recommendations to users regarding social interaction spaces within such environments.

### BRIEF DESCRIPTION OF THE DRAWINGS

For a better understanding of the present disclosure, reference is made to the following Detailed Description, taken in connection with the accompanying drawings, in which:

FIG. 1 is a flowchart showing overall processing steps of and exemplary embodiment of the present disclosure for synchronous recommendations of social interaction spaces to individuals;

FIG. 2 is a flowchart showing the exemplary social interaction environment profiling process of FIG. 1 in greater detail;

FIG. 3 is a flowchart showing the exemplary user profiling process of FIG. 1 in greater detail;

FIG. 4 is a flowchart showing an exemplary affinity measurement algorithm of FIG. 1 in greater detail; and

FIG. 5 is a diagram showing the system of the present disclosure implemented as middleware.

### DETAILED DESCRIPTION

The present disclosure provides a system and method for synchronous recommendations of social interaction spaces to individuals. As used herein, the terms “individual” and “user” are used interchangeably to refer to individuals or groups of individuals having access to and utilizing the systems and/or methods of the present disclosure to obtain a recommendation for a social interaction space. Real-time information about users and a social interaction environment are gathered. The term “real-time” refers to real-time or near real-time interaction and responses of users and the system of the present disclosure, similar to the term “synchronous, computer-mediated communications” as that term is used by Human-Computer Interaction (HCI) researchers. As used herein, the term “recommend” and “recommendations” refers not only to standard interpersonal recommendations, but to the use of computer systems to present through a user interface (of any form such as a graphical user interface, a haptic interface, an auditory interface, a multimodal interface, etc) information (current state, features, etc.) pertaining to a subset of items, objects, people, events, interaction spaces, etc., which they should consider as of relevance. Recommendations can be presented in a wide variety of ways, including, but not limited to, ordered lists, visualizations, conversational interfaces, etc. A real-time, general model of the social interaction environment, including social interaction space states, trajectories, and rhythms, is created, as well as real-time profiles of a community of users (including, but not limited to, user-generated preferences, patterns of collaboration, social network ties, etc.). Affinities are calculated between the social interaction spaces in the modeled environment and user profiles, and are utilized to provide quality social interaction space recommendations.

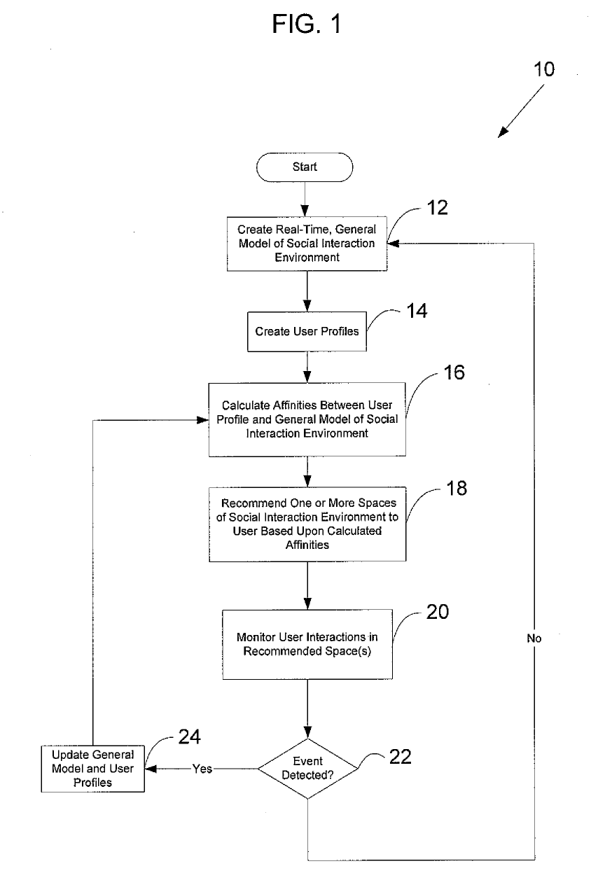

FIG. 1 is a flowchart showing overall processing steps of an exemplary implementation of the present disclosure, indicated generally at 10, for synchronous recommendations of social interaction spaces to users. In step 12, a real-time, general model of a social interaction environment is created and stored. The social interaction environment may include, but is not limited to, electronic communication systems such as a chat room, an online game interaction space (e.g., a virtual room displaying users' avatars), as well as physical spaces and/or activities such as meetings, social gatherings, venues, etc. As discussed below, real-time profiles of one or more social interaction spaces within the modeled environment are generated, including information about the availability of each space, the states of each space (e.g., the number of individuals present in each space), predictions about likely future states through analysis of trajectories and rhythms, and models of ideal social interaction space states in the environment. In step 14, a user's profile is created and stored. As discussed below, the profile could include information about the user's state (such as the user's location and engagement in various activities), as well as implicit and explicit preferences. Steps 12 and 14 allow for the generation of a real-time model of both a social interaction environment including its associated social interaction spaces, as well as the real-time profiling of users and user communities.

In step 16, affinities are calculated (e.g., in the form of a matrix) between the features of the interaction spaces in the general model of the social interaction environment and various aspects of the user profile. For example, if an interaction space Z is graphed as currently partially occupied by 13 individuals, supporting a university chess club meeting for students for 2 hours, with an ideal current occupancy value of 20, with a flat number of occupants trajectory for the next 4 hours, and an individual Y is graphed as currently being a student, having free time for a social interaction for the next 2 hours, as being interested in meeting chess players and playing chess, and is in location X which is a 5 minute walk from interaction space Z, then the affinities between the individual and the interaction space along the dimensions of “current activity” and “availability” could be scored as high and utilized to recommend space Z to user Y. It is noted that graphs of user community profiles could also be included, to describe features of interaction spaces (e.g., information that a specific location is used by individuals for eating, or that a space is a group hangout) and user profiles (e.g., information that a specific person interacts with people who enjoy soccer). In general, the stronger the affinities between the features of an interaction space in the graphed model and the features of a graphed user profile, the more likely it will be that there is a match between the individual and the interaction space suitable for recommendation to the individual.

Contextual constraint information, such as whether a particular space should not be recommended if an individual is already within the space, or if the space is already full to capacity, or if the availability of the space does not comport with an individual's schedule, can either be applied to the results of the affinity calculations or factored directly into the affinity calculation method itself. The affinity graph and the contextual restraints data are utilized by the present disclosure to create a ranked list of spaces for recommendation. Contextual constraint information may be utilized to describe features of spaces and individuals as part of the affinity graph. Contextual constraint information could also be utilized to adjust the ranked list of spaces for recommendation. It is also possible that contextual constraint information could form part of the affinity graph.

In step 18, one or more spaces of the social interaction environment are recommended to the user based upon a ranked list derived from the calculated affinities. At this point, the user can join the recommended social interaction space(s) and can interact with other users of the space. The quality of the recommendation can then be measured by monitoring user interactions within the recommended space(s) and/or the impacts of the user's actions within the space(s), as well as the user's reactions to the recommendation (to allow for highly-optimized future recommendations based upon the user's reactions). Optionally, surveys and/or polling of users could also be utilized to provide feedback as to the quality of the recommendation. Thus, in step 20, user interactions within the recommended space(s) are monitored. Then, in step 22, a determination is made as to whether an event is detected, including, but not limited to, the extent of the user's engagement in one or more social interaction environments or other desired effects. If so, step 24 occurs, wherein the general model of the social interaction environment and the user profile are updated.

Additionally, the monitored outcomes can be analyzed using one or more techniques, such as machine learning, Bayesian decision trees, neural network analysis, or other similar techniques, so as to refine the recommendation process using a feedback loop. Steps 16-18 are then repeated, so that affinities between the updated general model and the user profile can be calculated and, if desirable, new recommendations of social interaction spaces can be made. If a negative determination is made in step 22, no change to the general model and user profiles is required, and the processing shown in FIG. 1 is repeated continuously so that real-time modeling and synchronous recommendations can be generated. Also, the real-time information gathered in FIG. 1 about user profiles and the social interaction environment can be utilized to improve future recommendations, increase user confidence in recommendations that are made, and to reduce the impact of statistical outliers on the calculated affinities.

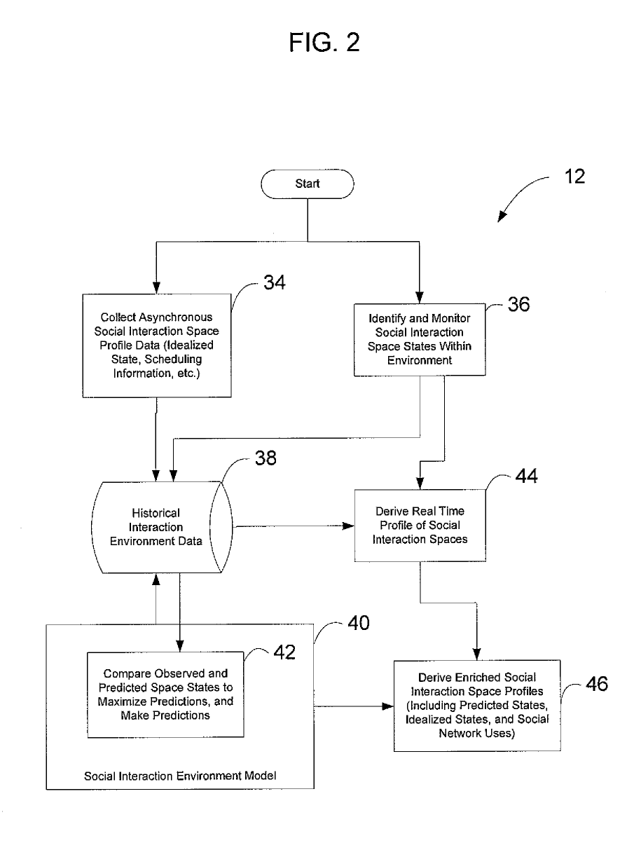

FIG. 2 is a flowchart showing the real-time, social interaction environment modeling step 12 of FIG. 1 in greater detail. In steps 34 and 36, existing social interaction spaces within the environment to be modeled are determined (step 36), and asynchronous profile data about such spaces are collected (e.g., idealized state information, scheduling information, etc.) (step 34). The spaces could correspond to physical locations within an area (e.g., classrooms or meeting rooms on a campus), as well as computer-mediated interaction spaces, such as chat channels hosted by a modeled chat network, or rooms, parks, etc. in a online gaming environment that allows user collaboration and interaction. In such environments, the social interaction spaces are dynamic. For example, the number and availability of rooms for public use on a campus may vary with time of day, or the number of chat channels hosted by a chat system may vary as users create such channels or allow them to cease. The information collected in steps 34 and 36 is stored in a historical interaction environment database 38. This information is used to create a general model 40 of the social interaction environment, which can be used in step 42 to make predictions about future space states based on current and historical space state data, and to compare observed and predicted space states to maximize predictions about future predictions. Such predictions can be stored in the database 38. The state could include information about how many individuals are located in the social interaction space, who is using the space, or other information. Historical space state data could be utilized to allow for richer profiling and/or descriptions of the social interaction space. For example, historical data can provide information about individuals who typically use a space, time when a space is typically occupied, and what types of individuals utilize a particular space, etc. Predictions about future space states, including short-term predictions (e.g., predictions about the number of individuals in a room based upon the number of individuals in the room for the past hour) and long-term predictions (e.g., predictions about the number of individuals in a room on a given day, based upon observations of previous days), could be produced by analysis and/or extrapolation of previously-observed space states. Further, the model 40 could be utilized to simulate hypothetical scenarios which can be used in the recommendation process. For example, if it is desired to make a recommendation about an optimal time to visit a club room which can accommodate only 100 people, a hypothetical scenario is modeled with various occupancy values to ascertain the optimal times at which to recommend the room to a user.

Predictive algorithms pertaining to the future states of interaction spaces, individuals and the user community can also be utilized by the model 40, and refined by applying various methods for predicting future states to a subset of historical data so as to make predictions about a second subset of historical data so that the correlation between the observed and predicted values can be computed. Approaches that result in a higher correlation between a observed and predicted values are preferable. Such correlations may pertain to a transformed measure of the observed or predicted values to deal with issues such as the nature of the prediction required or the underlying data (e.g., a non-normal distribution). For example, as predicting a chat channel occupancy to the exact number of individuals is likely to be of less relevance than the occupancy range of 20-30 users, the correlation might be based on a transformed range of observed and predicted values (e.g., if predicted value of users is 10—this might be considered a correct prediction if the actual observed number of individuals is between 7-13). As many of the variables used to describe environmental states will be non-linear, predictive algorithms that are based on regression analysis of historical data can be maximized by first transforming (e.g., logarithmically) the values of many of the historical variables. The predictive algorithms preferably combine a number of methods to achieve the best quality results. For example, the prediction of occupancy of an interaction space in the near future may best be achieved by incorporating: (1) a measure of the short-term trajectory of occupancy (e.g., 5 people every 10 minutes are arriving and 2 are leaving); (2) times series analysis (seasonal decomposition, ARIMA, etc.); and (3) scheduling data (e.g., the scheduling of an ad hoc event may mean that weight should be given to the typical occupancy of such events in the past; because this is ad hoc, the times series analysis will be unable to explain the said variance). The weighting of the various components of such predictive algorithms could be maximized by various regression modeling techniques applied to historical data. Additionally, trajectory data (including short-term and/or long-term trajectory data, as mentioned above) could include information about fluctuations in the number of people in a given social interaction space over time, and rhythm data could include activity patterns within the social interaction space.

In step 44, real-time profiles of social interaction spaces are derived utilizing the historical interaction environment data stored in the database 38. In step 46, enriched social interaction space profiles (including predicted states, idealized states, and social network uses) are derived. These profiles can be used in the affinity calculations/measurements and/or contextual constraints models discussed herein to recommend a social interaction space to a user. In particular, a dynamic list of social interaction spaces currently available to the user (e.g., which chat channels currently operate and are open to new users, or which community centers and other community spaces are open) could be generated by the disclosed systems and/or methods utilizing information stored in the social interaction space profile database 40.

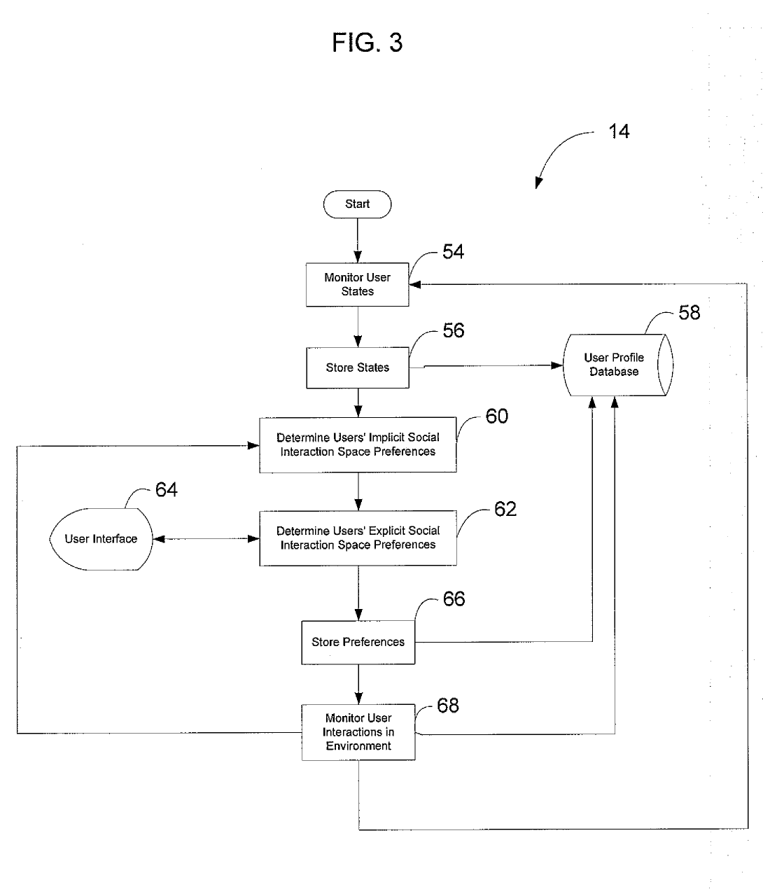

FIG. 3 is a flowchart showing the user profiling process 14 of FIG. 1 in greater detail. As mentioned above, the user profiling process 14 allows for the real-time profiling of information about a user, including the state of the user and implicit and explicit user preferences. Additionally, the profiling process 14 can be applied to profile a community of users (e.g., information about what types of people go to locations of interest, information about social network structures, social ties, etc.). Beginning in step 54, the user's state is monitored. The state could include information about the user's location and/or the user's engagement in an activity. This information could be acquired by monitoring the user's actions in an electronic communications system (such a chat channel), or by remotely monitoring the user's physical actions using sensors (e.g., using a door sensor for monitoring the number of individuals within a room, remotely monitoring the user's presence through tracking of cell phone signals, or other suitable type of remote sensing system/device, etc.). In step 56, the monitored state is stored in a user profile database 58. Then, in step 60, the user's implicit social interaction space preferences are determined. Implicit preferences can be inferred by the present disclosure by analyzing current behavior and/or historical user behavior. Such user behavior can be dynamic, such as the locations where a user goes in real-time in a social interaction environment, or asynchronous, such as slowly-changing user profile information including, but not limited to, individuals' likes and/or dislikes, social network ties information, and other information. For example, a new user logging into a chat system may enter in and out of various chat channels, saying “hello” to participants in a given chat channel but failing to engage other users in a discussion. This behavior could be utilized by the system of the present disclosure to infer that the user is searching for an available social interaction space that readily engages new users. Further, the type of chat channels already sampled in this manner by the user could be utilized to suggest preferences relating to the type and/or topic of chat channels that are best to recommend to the user. A user's implicit preferences could also be inferred by membership in a particular social group or network. For example, if a user belongs to a social group that typically goes to football matches an implicit preference for places where football is seen or discussed could be inferred.

Users' explicit social interaction space preferences could also be gathered and utilized in step 62. Such preferences could be specified by a user using computer user interface 64. For example, a user could complete a questionnaire about the types of social interaction spaces in which the user in interested. Additionally, explicit preferences could be provided using search tools which result in a real-time user request for a recommendation, and/or through the use of conversational interfaces that interactively query user preferences. An example of a conversational interface includes a “chat bot” (software agent) that asks a series of questions and uses responses to extract a list of explicit preferences.

In step 66, the implied and explicit user preferences are stored in the user profile database 66. In step 68, the user interactions within the environment (e.g., in one or more social interaction spaces) are monitored. This information is stored in the user profile database 58 and can be used in step 60 to refine implicit social interaction space preferences generated by the present invention, in a feedback loop. Additionally, the user community can be profiled to allow for the use of recommendation system techniques such as “collaborative filtering,” which can be utilized to support affinity measures for social interaction spaces. One example of the use of collaborative filtering is in a situation where a group of users prefer a particular social interaction space that has been visited by a single user, as well as other social interaction spaces that the user has not yet visited. This group preference can be utilized to suggest a high affinity between the user and the unvisited social interaction space. Other system techniques such as affinity measurement in social network structures could also be used to refine implicit recommendations generated by the system of the present disclosure (e.g., an individual user's friends prefer one or more social interaction spaces, and therefore the individual is also likely to enjoy such spaces). The processing steps of FIG. 3 are continually repeated, so that up-to-date, real-time profiling of users occurs. The information stored in the user profile database 58 is utilized by the affinity measurement conducted in step 16 of FIG. 1 to recommend one or more social interaction spaces to a user.

Data pertaining to the user's current context and history of use of the interaction environment is collected and analyzed to identify relevant contextual constraints to recommendations. These constraints ensure that the system does not make recommendations to individuals as to interaction spaces, with which they have a high affinity along a number of dimensions if the user's context negates/devalues these other dimensions in the affinity graph. For example, an individual with a high affinity to a particular interaction space along a large number of dimensions might not be recommended the space because: (i) they are currently in this space; (ii) they just left this space; or (iii) they frequent it so often that any such recommendation would be redundant. Such contextual constraints can be worked into the affinity graph itself as negative weights or used to filter recommendations. Another example of a possible contextual constraint is a constraint which states: “is predicted time to arrive at an interaction space, if recommended,” and wherein spaces that are too distant for the user to effectively act on the recommendation are not presented to the user. Distance could be gauged in terms of reaching the space in time to attend a particular event, or simply in terms of the physical effort the user would have to make. Predicted time to reach an interaction space could also be calculated based on a user's current physical location, means of transport, speed of walking and current geographic trajectory. Numerous other possible contextual constraints will exist for any given implementation of said system, all of which can either be utilized in the construction of the affinity graph or as a filter on potential recommendations.

In addition to standard techniques utilized by item-focused recommendation systems (such as requesting that users rate spaces and or space recommendations), the value of recommendations generated by the system of the present disclosure can also be assessed by monitoring user actions and/or reactions to the recommendation in a two-step process. First, the system could monitor which recommendations, and recommendation types, are typically acted upon, and which are ignored. The recommendations which are acted upon can be perceived to be of higher value than recommendations which are not acted upon. Second, the system can monitor the actions of individuals who act upon recommendations to see if the recommendations acted upon were of value to the user. This could be accomplished by monitoring the user's level of engagement in a recommended social interaction space, wherein high levels of engagement suggest that the recommendation was of high value. Knowledge of the value of the recommendations can then be fed back to the affinity measurement and/or recommendation processes disclosed herein to improve recommendation generation and presentation.

The processing logic shown in FIGS. 1-3 and described herein allows for the synchronous generation of user and social interaction space profiles, in real time. This allows for the dynamic generation of recommendations for users which can flexibly adapt to changes in user states and preferences as well as changes in social interaction spaces over time.

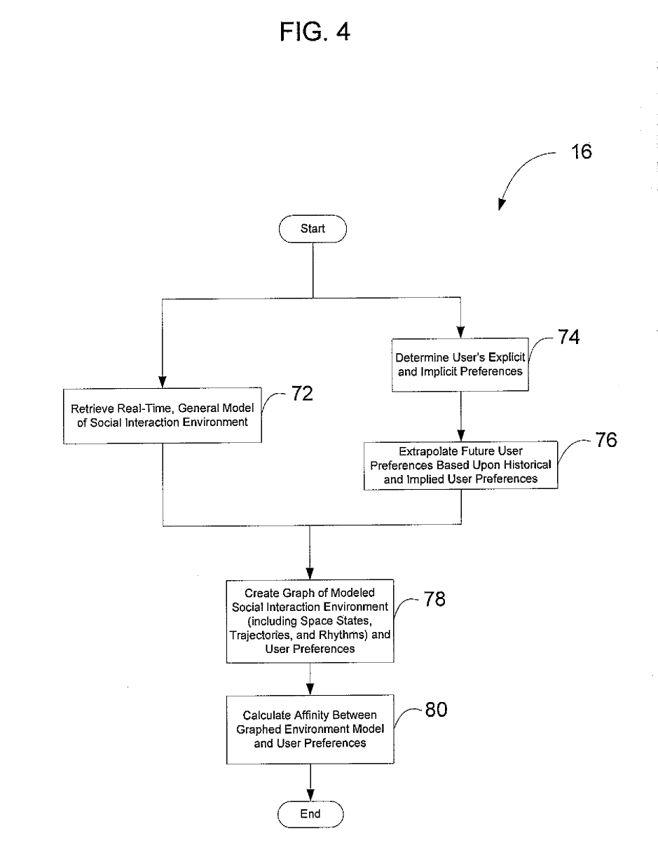

FIG. 4 is a flowchart showing, in greater detail, the affinity measurement algorithm implemented in step 16 of FIG. 1. As mentioned above, affinities between the real-time, general model of a social interaction environment (including its associated social interaction spaces) and user profiles (and, optionally, profiles of user communities) are utilized to recommend one or more social interaction spaces to a user. In step 72, the real-time, general model of the social interaction environment is retrieved (e.g., by retrieving the social interaction space profile data from the database 40 of FIG. 2). In step 74, the user's explicit and implicit preferences are determined. This information is retrieved from the user profile database 58 of FIG. 3, discussed above. In step 76, extrapolated user preferences are generated, from an analysis of the user's current state, recent activities, explicitly stated preferences, implied user preferences, etc., as discussed above. One example of extrapolated preference information includes activity type (e.g., a user would like to visit a place where the activity is discussion about software sharing). Other examples include, but are not limited to, preferred types of interaction dynamics (e.g., the user likely wishes to join a chat group where there is lively discussion between participants, based upon the user's previous chat group behavior), user population characteristics (e.g., the user likely wishes to join a group where participants are between the ages of 20 and 50, based upon age characteristics of similar chat rooms in which the user has participated), and rules of entry and responsibility (e.g., the user likely wishes to moderate a chat session, based upon previous roles as chat room moderator).

In step 78, a graph of the modeled social interaction environment (including space states, trajectories, and rhythms) is graphed, along with the user preferences determined in steps 74-76. One example of a social interaction space parameter that could be graphed includes space type (e.g., chat room, etc.). Other examples include, but are not limited to, interaction dynamics for the space, user population characteristics, and rules of entry and responsibility. Then, in step 80, an affinity calculation is performed on the graphed social interaction environment data and the graphed user profile data to determine the affinity therebetween (e.g., the extent to which the graphs are similar in appearance). This information is then utilized to recommend one or more of the modeled social interaction spaces to the user. The recommended space(s) could be presented to the user as a list which is sorted according to affinity, through a conversational interface (where a software agent interrogates/interacts with a user to determine preferences and present recommendations), or as a social visualization (in this case where a graphic visualization of an interaction space or numerous interaction spaces in an environment are presented through such visualization techniques as treemaps, tag clouds, etc.) or in any other desired fashion.

As noted above, the present disclosure could be utilized to make synchronized, real-time recommendations about a variety of social interaction environments, which could represent physical environments, virtual environments, or “mixed reality” environments. In the case of electronic social interaction environments, such as chat rooms, a general model of the chat room environment is created by collecting data about existing chat channels and typical user behavior (e.g., number of channels and system-wide rhythms), as well as other data. The same general model could be applied to various virtual reality environments supporting social interactions in constrained social interaction spaces, such as 3D rooms. Rich user data is also collected to create a profile of the user, including the user's typical behavior patterns. The general model describes the various rhythms, user interaction constraints, and norms of user behavior. The general model and user profile information is then graphed and the affinities are calculated based upon the similarities of these graphs (as described previously). Recommendations of one or more chat channels are then made based upon the calculated affinities.

In the context of the physical environments, such as urban enclaves, a general model of the social interaction environment is created. The model includes information about the range of possible interaction spaces, types, and occupancy levels over time, among other information (such as information as to how people utilize the interaction spaces). In the context of a university campus, the model would include information about all public spaces (classrooms, meeting rooms, dining areas, etc.), as well as usages of such spaces (e.g., through analysis of event calendars and user mobility traces, etc.). The modeled environment would then be graphed along with user profile information to calculate affinities based upon the similarities of the graphs (as described previously). One or more spaces within the environment would then be recommended to the user based upon these affinities. The affinity measures (or, optionally, contextual constraint models) would then take into account such issues as current user location and distance to potential social interaction spaces. Ubiquitous computing context mechanisms could be provided to enable users to identify and characterize interaction spaces (locations, typical activities, names, etc.), and analysis of mobile traces could be utilized to identify user behavior, such as to identify individually important places or group meeting places. For example, if a person has been located at specific types of events in the past, this information could be utilized to recommend similar locations in the future. Also, collaborative filtering and/or recommendations based upon social network structures, both discussed above, can be utilized to provide quality recommendations.

It is noted that the processing steps of the present disclosure could be implemented using any suitable programming language to create a system for synchronous recommendations of social interaction spaces to individuals. For example, the method disclosed herein could be implemented as middleware which leverages and/or supports the interaction environment model and recommendation system output from a variety of applications. Such middleware could also include one or more software modules for collecting user and social interaction space data to generate social interaction space recommendations from numerous devices, sensors, and users in an environment. Deriving data from, as well as providing data to, various applications could provide quality recommendations on a campus, urban enclave, or even regional scale. Additionally, recommendations can be presented back to users utilizing one or more independent or related applications via the aforementioned middleware. For example, recommendations of where to visit could be provided via such middleware to a number of related applications, such as a location-aware cell phone application that presents a dynamic list of relevant online and physical spaces to visit users. Additionally, the methods of the present disclosure could be implemented using software agents running inside a chat network, or utilizing a website that describes and/or visualizes places in the environment. A richer example in the context of an urban enclave system for a downtown campus could be that individual profile data is collected simultaneously from a social networking site, and a location-aware social matching cell phone application and feed into the recommendation system profile modeling middleware, while occupancy information could be collected from environmental sensors as well as from the location aware social matching cell phone application, and place descriptions and idealized states could be extracted from a location-linked wiki or geographical information system (GIS), and then the recommendations generated could be presented back to the user inside a location-aware cell phone social navigation tool that describes and recommends social interaction spaces in the users environment. Social interaction space data could be extracted from a location-linked “wiki” and/or location-activity calendaring systems, as well as other systems which describe social interaction spaces.

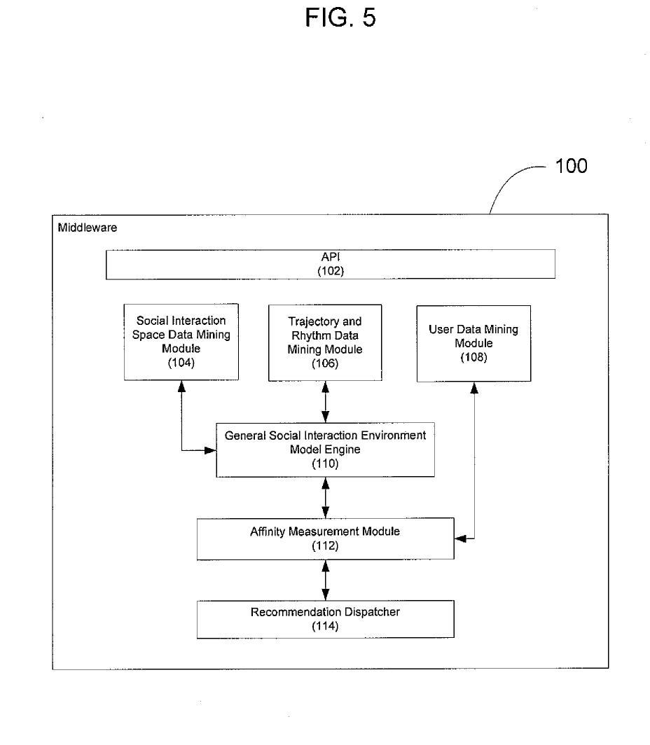

As shown in FIG. 5, the middleware 100 could reside on any suitable computer system (e.g., a computer and/or web server) which could be interconnected with a computer network, such as a campus network, an intranet, or the Internet. Alternatively, the middleware 100 could operate locally (e.g., on a thin client or a mobile computing device) with network connectivity. The middleware 100 could also be created with its own set of Application Programming Interfaces (APIs) 102 for allowing programmers to easily incorporate the functionality of any of the middleware components into other software applications. Additionally, the middleware could be designed to include a social interaction space data mining module 104 which gathers and profiles social interaction spaces in the manner disclosed herein, a social interaction space trajectory and rhythm data mining module 106, a user data mining module 108 which gathers and profiles users (including both explicit and implicit user preference data, as well as reactions of individuals to previously-generated recommendations to improve future recommendations), a general social interaction environment model engine 110 for generating a general model of the social interaction environment (as discussed herein) based upon data gathered by the modules 104 and 106, an affinity measurement module 112 which performs the affinity measurement/calculation processes disclosed herein to recommend a social interaction space to a user, and a recommendation delivery event dispatcher 114 which dispatches recommendations to users.

Having thus described exemplary embodiments and implementations of the present invention in detail, it is to be understood that the foregoing description is not intended to limit the spirit and scope thereof.

What is claimed is:

1. A method for recommending a social interaction space to an individual, comprising the steps of:
creating a model of a social interaction environment based upon real-time information gathered about the social interaction environment, wherein the social interaction environment includes a plurality of social interaction spaces;
creating a profile of an individual based upon user information gathered relating to an individual's behavior and preferences;
graphing the model and the profile;
calculating an affinity matrix utilizing the graph of the model and the graph of the profile, wherein the affinity matrix is indicative of similarities therebetween; and
recommending at least one of the social interaction spaces for the individual utilizing the affinity matrix.

2. The method of claim 1, wherein the step of calculating the affinity includes extrapolating future preferences of the individual based on historical data.

3. The method of claim 1, further comprising monitoring interactions of the individual within the social interaction environment and updating the model based upon the monitored interactions.

4. The method of claim 3, further comprising recommending at least one of the social interaction spaces to the individual based upon the monitored interactions.

5. The method of claim 1, further comprising optimizing future recommendations for the individual.

6. The method of claim 5, wherein the future recommendations are optimized by at least one of: (i) processing historical data (ii) monitoring the individual's reaction to prior recommendations, (iii) processing prior recommendations using a collaborative filtering process, (iv) processing prior recommendations using social network data, and (v) correlating predicted states and observed states of the social interaction spaces.

7. The method of claim 6, wherein the state of each social interaction space is predicted using one or more techniques selected from the group comprising: (i) analyzing short-term trajectory data corresponding to the social interaction space, (ii) analyzing long-term trajectory data corresponding to the social interaction space, (iii) applying a time-series analysis to the social interaction space, and (iv) analyzing scheduling data corresponding to the social interaction space.

8. The method of claim 7, wherein regression modeling of the historical data for the social interaction space is used to weight each of the one or more techniques.

9. The method of claim 1, further comprising recommending at least one of the social interaction spaces for the individual based upon group preferences.

10. The method of claim 1, further comprising recommending at least one of the social interaction spaces for the individual by measuring affinities between a social network structure of the individual and the model of the social interaction environment.

11. The method of claim 1, further comprising presenting recommendations to the individual through a conversational interface.

12. The method of claim 1, further comprising presenting recommendations to the individual through a social visualization technique.

13. A system for recommending a social interaction space to an individual, comprising:
a first software module for gathering real-time information about a social interaction environment, wherein the social interaction environment includes a plurality of social interaction spaces;
a second software module for gathering user information relating to an individual's behavior and preferences;
means for creating a model of the social interaction environment based upon the real-time information;
means for creating a profile of the individual based upon the user information;
means for calculating an affinity between the model of the social interaction environment and the profile of the individual; and
means for recommending at least one of the social interaction spaces for the individual utilizing the affinity.

14. The system of claim 13, wherein the means for calculating the affinity includes means for extrapolating future preferences of the individual based on historical data.

15. The system of claim 13, further comprising means for monitoring interactions of the individual within the social interaction environment and means for updating the model based upon the monitored interactions.

16. The system of claim 15, further comprising means for recommending at least one of the social interaction spaces to the individual based upon the monitored interactions.

17. The system of claim 13, further comprising means for optimizing future recommendations.

18. The system of claim 17, wherein the means for optimizing future recommendations includes means for at least one of (i) processing historical data gathered by the first and second software modules (ii) monitoring the individual's reaction to prior recommendations, (iii) processing prior recommendations using a collaborative filtering process, (iv) processing prior recommendations using social network data, and (v) correlating predicted states and observed states of the social interaction spaces.

19. The system of claim 18, further including means for predicting the state of each social interaction space using one or more techniques selected from the group comprising: (i) analyzing short-term trajectory data corresponding to the social interaction space, (ii) analyzing long-term trajectory data corresponding to the social interaction space, (iii) applying a time-series analysis to the social interaction space, and (iv) analyzing scheduling data corresponding to the social interaction space.

20. The system of claim 19, wherein regression modeling of the historical data is used to weight each of the one or more techniques.
